(19) United States
(12) Patent Application Publication
(10) Pub. No.: US 2024/0429734 A1
(43) Pub. Date: Dec. 26, 2024

(54) BATTERY CHARGING APPARATUS

(71) Applicants: Hyundai Motor Company, Seoul (KR); Kia Corporation, Seoul (KR)

(72) Inventors: Young Jin Jang, Seoul (KR); Hye Seung Kim, Gunpo-si (KR); Won Yong Sung, Hwaseong-si (KR)

(21) Appl. No.: 18/497,702

(22) Filed: Oct. 30, 2023

(30) Foreign Application Priority Data
Jun. 22, 2023 (KR) 10-2023-0080529

(51) Int. Cl. H02J 7/14; B60L 53/53; B60L 55/00

(52) U.S. Cl. CPC H02J 7/1438; B60L 53/53; B60L 55/00; H02J 2207/10

(57) ABSTRACT

In an embodiment, a battery charging apparatus includes a charging and discharging port, a power factor correction circuit having first to third inductors, a first relay, an interleave relay, and a controller configured to control a connected or disconnected state of the first relay, and a connected or disconnected state of the interleave relay, such that the battery charging apparatus is configured to transfer an external electric power to a battery through the charging and discharging port, or to transfer a battery electric power of the battery to an external source through the charging and discharging port.

### CROSS-REFERENCE TO RELATED APPLICATIONS

This application claims the benefit of Korean Patent Application No. 10-2023-0080529, filed on Jun. 22, 2023, which application is hereby incorporated herein by reference.

### TECHNICAL FIELD

The present disclosure relates to a battery charging apparatus.

### BACKGROUND

In recent years, in accordance with a global trend toward reducing carbon dioxide emissions, instead of typical combustion engine-equipped vehicles that generate driving power for traveling through combustion of fossil fuel, there has been an ever-increasing demand for electrified vehicles that generate driving power for traveling by driving a motor with electric energy stored in an energy storage apparatus, such as a battery.

The electrified vehicle may be equipped with an on-board charger (OBC) that charges a battery with an electric power system. Usually, the OBC is configured with a power factor correction circuit (PFC) that converts an external alternating-current voltage into a direct-current voltage, and a DC/DC converter that adjusts the conversion-resulting direct-current voltage to voltage required of a battery.

In recent years, with an increase in the capacity of the battery provided in the electrified vehicle, vehicle-to-grid (V2G) and vehicle-to-load (V2L) technologies for supplying energy stored in the battery to a system and an electric load through the OBC have been under development.

The foregoing is intended merely to aid in the understanding of the background of the present disclosure, and is not intended to mean that the present disclosure falls within the purview of the related art that is already known to those skilled in the art.

### SUMMARY

The present disclosure relates to a battery charging apparatus capable of providing an isolating function through the use of a relay. An embodiment of the present disclosure is a battery charging apparatus capable of enabling a plurality of relays to share an isolating function, ensuring an improvement in isolating performance and a reduction in manufacturing costs.

The present disclosure is not limited to the above-mentioned advantages. From the following description, advantages not mentioned would be clearly understandable by a person of ordinary skill in the art to which the present disclosure pertains.

In order to accomplish the above-mentioned advantages, according to an embodiment of the present disclosure, a battery charging apparatus includes a charging and discharging port having first to third charging and discharging alternating-current terminals and a neutral terminal, where an external electric power is transferred to a battery through the charging and discharging port or an electric power of the battery is transferred to an external source through the charging and discharging port. In an embodiment, a battery charging apparatus further includes a power factor correction circuit having first to third inductors that correspond to the first to third charging and discharging alternating-current terminals, respectively. In an embodiment, a battery charging apparatus further includes a first relay electrically connected between the first charging and discharging alternating-current terminal and the first inductor. In an embodiment, a battery charging apparatus further includes an interleave relay, one end thereof being electrically connected between the first charging and discharging alternating-current terminal and the first relay, and the other end thereof being electrically connected between the second charging and discharging alternating-current terminal and the second inductor. And in an embodiment, a battery charging apparatus further includes and a controller configured to control a connected or disconnected state of the first relay and a connected or disconnected state of the interleave relay.

In the battery charging apparatus, the first relay and the interleave relay may have respective current capacities that are equivalent to each other.

In the battery charging apparatus, a single-phase alternating current power may be input into the first charging and discharging alternating-current terminal.

In the battery charging apparatus, alternating current powers that correspond to three phases, respectively, of a three-phase alternating current power may be input into the first to third charging and discharging alternating-current terminals, respectively.

In the battery charging apparatus, a second relay, a third relay, and a neutral terminal relay may be connected to the second charging and discharging alternating-current terminal, the third charging and discharging alternating-current terminal, and the neutral terminal, respectively.

In the battery charging apparatus, the controller may connect the first relay and the interleave relay in order to transfer the electric power of the battery to the external source through the charging and discharging port.

The battery charging apparatus may further include a pre-charging relay in series connected to a pre-charging resistor between one end of the first relay and the other end of the first relay.

In the battery charging apparatus, the pre-charging relay may have a lower current capacity than the first relay.

In the battery charging apparatus, in a case where an alternating current power starts to be input into the first charging and discharging alternating-current terminal, the controller may control the pre-charging relay in such a manner as to be connected.

In the battery charging apparatus, when a voltage applied to the first inductor falls within a preset range, the controller may disconnect the pre-charging relay.

The battery charging apparatus may further include a discharging port having a first discharging alternating-current terminal and a second discharging alternating-current terminal, the electric power of the battery being transferred to the external source through the discharging port.

In the battery charging apparatus, one end of the discharging port may be electrically connected between the interleave relay and the second inductor, and the other end thereof may be electrically connected between the third charging and discharging alternating-current terminal and the third inductor.

The battery charging apparatus may further include a discharging relay electrically connected between the first discharging alternating-current terminal and the second discharging alternating-current terminal.

In the battery charging apparatus, the controller may connect the discharging relay in order to transfer the electric power of the battery through the discharging port.

In the battery charging apparatus, the controller may selectively connect or disconnect the first relay, the interleave relay, and the discharging relay in respect of a discharge mode of the battery.

In the battery charging apparatus, when the discharging mode of the battery is a first battery discharging mode for transferring the electric power of the battery to the external source through the charging and discharging port, the controller may connect the first relay and the interleave relay and disconnect the discharging relay.

In the battery charging apparatus, when the discharging mode of the battery is a second battery discharging mode for transferring the electric power of the battery to the external source through the discharging port, the controller may connect the discharging relay and disconnect the first relay and the interleave relay.

In the battery charging apparatus, when the discharging mode of the battery is a simultaneous driving mode for transferring the electric power of the battery to the external source through the charging and discharging port and the discharging port, the controller may connect the first relay, the interleave relay, and the discharging relay.

In an embodiment of the present disclosure, the plurality of relays can be enabled to share the isolating function of isolating electric power from the external source. This can decrease a current capacity required of each relay can decrease, thereby achieving a reduction in size and manufacturing costs.

In addition, in an embodiment, isolation between different discharging ports can be performed through the plurality of relays provided to isolate electric power from the external source. This can eliminate the need for a separate delay for isolation between the discharging ports, thereby also achieving a reduction in manufacturing costs.

The present disclosure is not necessarily limited to the effects mentioned above. From the following detailed description, an effect not mentioned would be clearly understandable by a person of ordinary skill in the art to which the present disclosure pertains.

### BRIEF DESCRIPTION OF THE DRAWINGS

The above and other features and advantages of the present disclosure can be more clearly understood from the following detailed description when taken in conjunction with the accompanying drawings, in which:

FIG. 1 is a view illustrating a circuit in a battery charging apparatus according to an embodiment of the present disclosure;

FIG. 2 is a block diagram that is referred to for description of a flow of a current through a first relay, an interleave relay, and a pre-charging relay according to an embodiment of the present disclosure; and

FIG. 3 is a block diagram that is referred to for description of control in a battery charging mode according to an embodiment of the present disclosure.

### DETAILED DESCRIPTION OF ILLUSTRATIVE EMBODIMENTS

An embodiment of the present disclosure, which is disclosed in the present specification, is provided only for the purpose of describing the present disclosure in terms of specific examples of structures or functions. An embodiment of the present disclosure may be practiced in various forms, and the present disclosure should not be construed as being necessarily limited to the embodiments that are described in the present specification.

Various modifications may be made to an embodiment of the present disclosure, and thus, an embodiment of or an embodiment based on the present disclosure may have various forms. Therefore, embodiments are specifically illustrated in the drawings and described in detail in the present specification. However, the present disclosure is not intended to be limited to an embodiment specifically illustrated in the drawings, and all modifications, equivalents, substitutions that are included within the technical ideas of the present disclosure should be understood as also falling within the scope of the present disclosure.

Unless otherwise defined, each of all the terms used throughout the present specification, including technical or scientific terms, can have the same meaning as is normally understood by a person of ordinary skill in the art to which the present disclosure pertains. A term as defined in commonly used dictionaries can be construed as having the same contextual meaning as that used in the relevant field of technology and, unless otherwise explicitly defined in the present specification, should not necessarily be construed as having an excessively implied meaning or a purely literal meaning.

For the purpose of disclosure, an embodiment of the present disclosure will be described in detail below referring to the accompanying drawings. The same or similar constituent elements are given the same reference numeral, and descriptions thereof might not be repeated.

Throughout the present specification, when the term “preset” is placed immediately before a parameter associated with a process or an algorithm, a preset parameter can mean that a numerical value of the parameter is predetermined or selected. The numerical value of the parameter may be set when the process or the algorithm starts to be performed or executed according to the embodiment of the present disclosure or may be set while the process or the algorithm is performed or is executed.

The terms “module” and “unit” are hereinafter interchangeably or individually used to refer to a constituent element only for convenience in description in the present specification and therefore are not necessarily themselves intended to take on different meanings or to depict different functions.

In describing an embodiment of the present disclosure, a detailed description of a well-known technology related thereto can be omitted when determined as making the nature and gist of the present disclosure obfuscated. In addition, the accompanying drawings serve only to help easily understand embodiments disclosed in the present specification. It should be understood that the technical ideas disclosed in the present specification are not necessarily limited by the accompanying drawings and that any alteration of, any equivalent of, and any substitute for, a constituent element according to the present disclosure that fall within the scope of the technical ideas of the present disclosure can also be included within the scope of the present disclosure.

The terms “first,” “second,” and so on can be used to describe various constituent elements that have the same function, but do not impose any limitation on the meanings of the various constituent elements. These terms can be used only to distinguish among the various constituent elements that have the same function.

It should be understood that a constituent element, when referred to as being “coupled to” or “connected to” a different constituent element, may also be directly coupled to or directly connected to the different constituent element or may also be coupled to or connected to the different constituent element with one or more constituent elements in between. Likewise, it should be understood that a constituent element, when referred to as being “directly coupled to” or “directly connected to” a different constituent element, may be coupled to or connected to the different constituent element without a third constituent element in between.

A noun in singular form has the same meaning as when used in plural form, unless it has a different meaning in context.

The terms “include,” “have,” and the like in the present application are intended to indicate that a feature, a number, a step, an operation, a constituent element, a component, or a combination of these, which is described in the specification, is present, and thus should be understood not to preclude the possibility that one or more other features, numbers, steps, operations, constituent elements, components, or combinations of these can be present or added.

A controller may include a communication device that communicates with another controller or a sensor in order to control a function for which the controller is responsible, a memory in which an operating system, a logic command, input and output information, and the like are stored, and one or more processors that perform judgment, computation, determination, and the like that can be necessary to control the function for which the controller is responsible.

A battery charging apparatus according to an embodiment of the present disclosure may enable a plurality of relays to share an isolating function that isolates system electric power from a battery. Thus, a burden of electric power that is applied to each of the plurality of relays can be alleviated, thereby ensuring that each of the plurality of relays efficiently performs the isolating function. Accordingly, it is proposed that a current capacity required of each relay can decrease to achieve a reduction in size and manufacturing cost and that the battery charging apparatus can efficiently perform the isolating function.

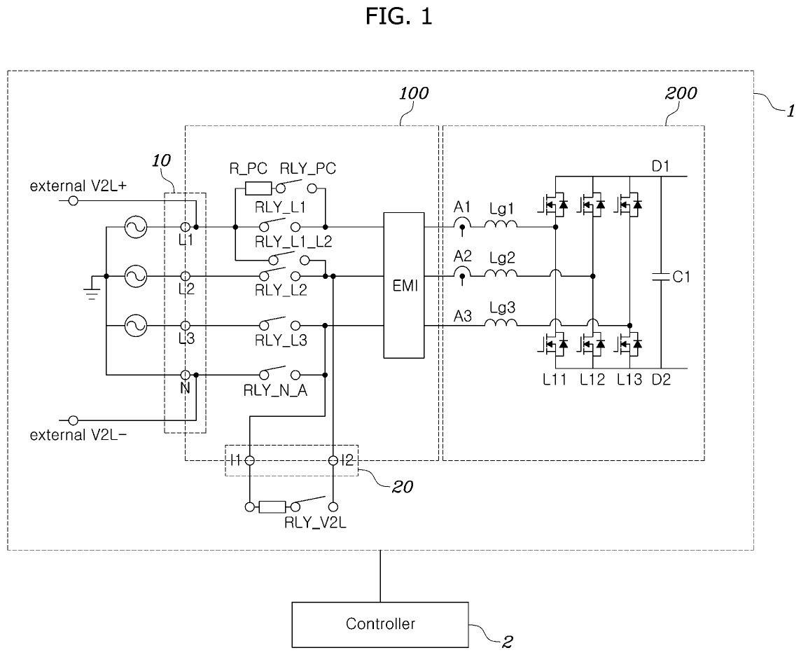

A battery charging apparatus according to an embodiment of the present disclosure will be described below with reference to FIGS. 1 to 3.

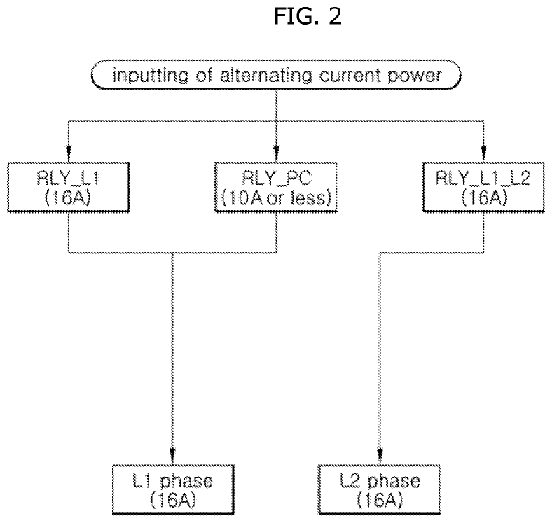

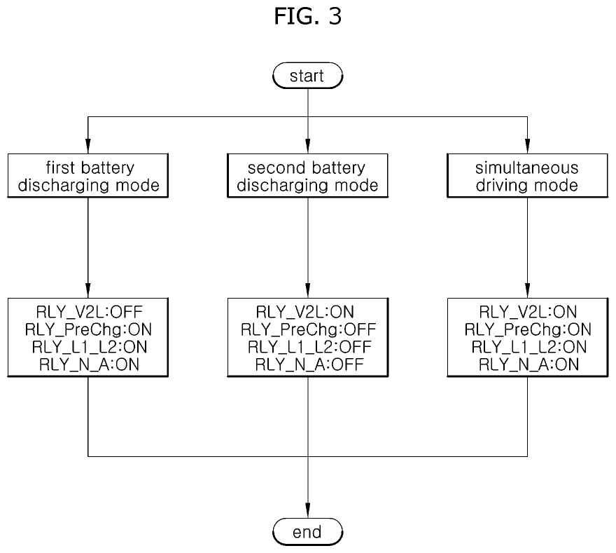

FIG. 1 is a view illustrating a circuit in a battery charging apparatus according to an embodiment of the present disclosure. FIG. 2 is a block diagram that is referred to for description of a flow of a current through a first relay, an interleave relay, and a pre-charging relay according to an embodiment of the present disclosure. FIG. 3 is a block diagram that is referred to for description of control in a battery charging mode according to an embodiment of the present disclosure.

First, with reference to FIG. 1, the battery charging apparatus may include a bidirectional charger 1 and a controller 2. FIG. 1 illustrates, in a focused manner, constituent elements associated with an embodiment of the present disclosure. Of course, a battery charging apparatus of an embodiment may be configured to further include one or more constituent elements or to omit one or more existing constituent elements.

First, the bidirectional charger 1 may include a charging and discharging port 10, a discharging port 20, an input circuit 100, and a power factor correction circuit (PFC) 200. The bidirectional charger 1 may further include an output terminal (not illustrated), which is configured to connect to a battery, and a DC/DC converter (not illustrated).

The charging and discharging port 10 may include a first charging and discharging alternating-current terminal L1, a second charging and discharging alternating-current terminal L2, a third charging and discharging alternating-current terminal L3, and a neutral terminal N. The charging and discharging port 10 may support a battery charging mode for transferring an external electric power to the battery and a battery discharging mode for transferring an electric power of the battery to an external source. In this case, the charging and discharging port 10 may be provided outside an electrified vehicle, but is not necessarily limited to this position. According to an embodiment of the present embodiment, the battery discharging mode may refer to a vehicle-to-load (V2L) mode for transferring the electric power of the battery to the external source.

In an embodiment, the battery charging mode may include a first battery charging mode for applying a three-phase alternating current power to the charging and discharging port 10 and a second battery charging mode for applying a single-phase alternating current power to the charging and discharging port 10.

In the second battery charging mode, the single-phase alternating current power may be input into the first charging and discharging alternating-current terminal L1. In the first battery charging mode, alternating current powers that correspond to three phases, respectively, of the three-phase alternating current power may be input into the first to third charging and discharging alternating-current terminals L1 to L3, respectively.

The battery discharging mode will be described below.

The discharging port 20 may include a first discharging alternating-current terminal I1 and a second discharging alternating-current terminal 12 and may support the battery discharging mode for transferring the electric power of the battery to the external source. In this case, the discharging port 20 may be provided inside the electrified vehicle, but is not necessarily limited to this position.

In an embodiment, one end of the discharging port 20 is electrically connected between an interleave relay RLY_L1_L2 and a second inductor Lg2, as shown in FIG. 1. The other end thereof may be electrically connected between the third charging and discharging alternating-current terminal L3 and a third inductor Lg3.

In an embodiment where only the charging and discharging port 10 is provided to the bidirectional charger 1, the electric power of the battery may be transferred only through the charging and discharging port 10. However, in an embodiment where the charging and discharging port 10, along with the discharging port 20, is provided to the bidirectional charger 1, the electric power of the battery may be transferred to the external source through only the discharging port 20, or through both the discharging port 20 and the charging and discharging port 10.

As shown in FIG. 1, a discharging relay RLY_V2L may be electrically connected between the first discharging alternating-current terminal I1 and the second discharging alternating-current terminal 12 of the discharging port 20. In this case, when the discharging relay RLY_V2L is connected therebetween, the electric power of the battery may be transferred through the discharging port 20. Furthermore, when the discharging relay RLY_V2L is disconnected, the electric power of the battery cannot be transferred to the external source through the discharging port 20.

As shown in FIG. 1, the input circuit 100 may include an electromagnetic interference (EMI) filter, a pre-charging relay RLY_PC, a first relay RLY_L1, an interleave relay RLY_L1_L2, a second relay RLY_L2, a third relay RLY_L3, and a neutral terminal relay RLY_N_A.

The first relay RLY_L1 may be electrically connected between the first charging and discharging alternating-current terminal L1 and the first inductor Lg1.

As shown in FIG. 1, one end of the interleave relay RLY_L1_L2 may be electrically connected between the first charging and discharging alternating-current terminal L1 and the first relay RLY_L1. The other end thereof may be electrically connected between the second charging and discharging alternating-current terminal L2 and the second inductor Lg2.

In this case, when the first relay RLY_L1 and the interleave relay RLY_L1_L2 are turned on to establish connections, respectively, an external electric power that is input into the first charging and discharging alternating-current terminal L1 may be distributed to each of the first relay RLY_L1 and the interleave relay RLY_L1_L2, or the electric power of the battery may be transferred to the external source. Furthermore, when the first relay RLY_L1 and the interleave relay RLY_L1_L2 are turned off to establish disconnections, respectively, the battery is isolated from the external source. Thus, the electric power of the battery cannot be transferred to the external source, or the external electric power cannot be transferred to the battery.

In a case where the first relay RLY_L1 is arranged more forward toward the first charging and discharging alternating-current terminal L1 than the interleave relay RLY_L1_L2, the first relay RLY_L1 has to be responsible for an entire current flowing through the first charging and discharging alternating-current terminal L1. As a result, a comparatively high current capacity is required of the first relay RLY_L1. However, the external electric power that is input into the first charging and discharging alternating-current terminal is distributed to the first relay RLY_L1 and the interleave relay RLY_L1_L2. Thus, a relay with a relatively low current capacity may also be used as the first relay RLY_L1.

Currents that flow through the first relay RLY_L1 and the interleave relay RLY_L1_L2 may be input into the first inductor Lg1 and the second inductor Lg2, respectively. The currents that are input into the first inductor Lg1 and the second inductor Lg2 may be the same or be equivalent to each other.

Therefore, in an embodiment, the first relay RLY_L1 and the interleave relay RLY_L1_L2 may have respective current capacities that are equivalent to each other. Currents that are the same or are equivalent to each other may flow to the first relay RLY_L1 and the interleave relay RLY_L1_L2. For example, the first relay RLY_L1 and the interleave relay RLY_L1_L2 may both have a current capacity of 16 A.

As shown in FIG. 1, the pre-charging relay RLY_PC may be in series connected to a pre-charging resistor R_PC between one end of the first relay RLY_L1 and the other end of the first relay RLY_L1.

The pre-charging relay RLY_PC may be connected in a case where an alternating current power starts to be input into the first charging and discharging alternating-current terminal L1 and may be disconnected in a case where the alternating current is input into the first charging and discharging alternating-current terminal L1 and then a voltage applied to the first inductor Lg1 falls within a preset range. For example, the pre-charging relay RLY_PC may be disconnected after the voltage applied to the first inductor Lg1 reaches a peak.

In a case where the pre-charging relay RLY_PC is connected, a current flowing through the first charging and discharging alternating-current terminal L1 may be distributed to the first relay RLY_L1, the interleave relay RLY_L1_L2, and the pre-charging resistor R_PC. In a case where the pre-charging relay RLY_PC is disconnected, the current flowing through the first charging and discharging alternating-current terminal L1 may be distributed only to the first relay RLY_L1 and the interleave relay RLY_L1_L2.

While the pre-charging relay RLY_PC is connected, a pre-charging operation for stabilizing a voltage through the pre-charging resistor R_PC is performed. Only when a low-load operation, referred to as the pre-charging operation, is performed, a current flows through the pre-charging relay RLY_PC. Therefore, the pre-charging relay RLY_PC may have a lower current capacity than the first relay RLY_L1. In addition, the pre-charging relay RLY_PC may also have a lower current capacity than the interleave relay RLY_L1_L2. The current capacity will be described below with reference to FIG. 2.

FIG. 2 is the diagram that is referred to for the description of the flow of a current through the first relay (RLY_L1), the interleave relay (RLY_L1_L2), and the pre-charging relay (RLY_PC), in accordance with an embodiment of the present disclosure.

With reference to FIG. 2, when the first relay RLY_L1 and the interleave relay RLY_L1_L2 have a current capacity of 16 A, the pre-charging relay RLY_PC may have a current capacity of 10 A or less, for example.

With reference back to FIG. 1, in a case where an alternating current power starts to be input through the first charging and discharging alternating-current terminal L1, at an initial phase, the first relay RLY_L1, the pre-charging relay RLY_PC, and the interleave relay RLY_L1_L2 may all be in a connected state in order to perform the pre-charging operation. At this point, one portion of a current flowing through the first charging and discharging alternating-current terminal L1 may be distributed to the interleave relay RLY_L1_L2, and the remaining portion thereof may be distributed to the first relay RLY_L1 and the pre-charging relay RLY_PC. The distribution of a current between the first relay RLY_L1 and the pre-charging relay RLY_PC may be determined according to a size of the pre-charging resistor R_PC.

In a case where the pre-charging operation is no longer performed, the pre-charging relay RLY_PC is disconnected. Thus, one portion of the current flowing through the first charging and discharging alternating-current terminal L1 may be distributed to the interleave relay RLY_L1_L2, and the remaining portion thereof may be distributed to the first relay RLY_L1. At this point, a current flowing through the first relay RLY_L1 or the pre-charging relay RLY_PC has a phase corresponding to the first charging and discharging alternating-current terminal L1 and may be transferred to the first inductor Lg1. Furthermore, a current flowing through the second relay RLY_L2 has a phase corresponding to the second charging and discharging alternating-current terminal L2 and may be transferred to the second inductor Lg2.

Still referring to FIG. 1, the second relay RLY_L2 may be connected between the second charging and discharging alternating-current terminal L2 of the charging and discharging port 10 and the second inductor Lg2 of the power factor correction circuit 200.

The third relay RLY_L3 may be connected between the third charging and discharging alternating-current terminal L3 of the charging and discharging port 10 and the third inductor Lg3 of the power factor correction circuit 200.

The neutral terminal relay RLY_N_A may be connected between the neutral terminal N of the charging and discharging port 10 and the third inductor Lg3 of the power factor correction circuit 200.

In an embodiment, as shown in FIG. 1, the power factor correction circuit 200 may include the first inductor Lg1, the second inductor Lg2, and the third inductor Lg3 that correspond to the first charging and discharging alternating-current terminal L1, the second charging and discharging alternating-current terminal L2, and the third charging and discharging alternating-current terminal L3, respectively. The power factor correction circuit 200 may further include a first leg L11, a second leg L12, a third leg L13, and a DC capacitor C1.

Still referring to FIG. 1, the DC capacitor C1 may be connected between a first direct-current terminal D1 and a second direct-current terminal D2.

The first leg L11 may include two switch elements that are in series connected to each other between the first direct-current terminal D1 and the second direct-current terminal D2 and may have an alternating-current terminal that is connected to a first alternating-current terminal A1 of the power factor correction circuit 200 through the first inductor Lg1.

The second leg L12 includes two switch elements that are in series connected to each other between the first direct-current terminal D1 and the second direct-current terminal D2 and may have an alternating-current terminal that is connected to a second alternating-current terminal A2 of the power factor correction circuit 200 through the second inductor Lg2.

The third leg L13 may include two switch elements that are in series connected to each other between the first direct-current terminal D1 and the second direct-current terminal D2 and may have an alternating-current terminal that is connected to a third alternating-current terminal A3 of the power factor correction circuit 200 through the third inductor Lg3. In this case, the neutral terminal relay RLY_N_B that is in series connected to the third inductor Lg3 may be provided together.

Although not illustrated in FIG. 1, the bidirectional charger 1 according to an embodiment of the present disclosure may further include a DC/DC converter. The DC/DC converter may be connected between the direct-current terminal D1 or D2 of the power factor correction circuit 200 and the output terminal to which the battery is connected and may convert a direct current voltage between the direct-current terminal D1 or D2 and the output terminal.

The DC/DC converter of an embodiment may include a first switching circuit, a second switching circuit, a transformer, and a DC capacitor, for example. In this case, the transformer may be connected between the first switching circuit and the second switching circuit, and the DC capacitor may be connected between a positive (+) pole of the battery and a negative (−) pole thereof.

The controller 2 may connect or disconnect the first relay RLY_L1, the interleave relay RLY_L1_L2, the pre-charging relay RLY_PC, the discharging relay RLY_V2L, and the like.

With connecting and disconnecting operations, the controller 2 may control the bidirectional charger 1 in such a manner that it executes a battery charging mode for charging the battery with an outside direct current power and a battery discharging mode for discharging the electric power of the battery to the charging and discharging port 10 and/or the discharging port 20.

In this case, for an embodiment, the battery charging mode may include a first battery charging mode for applying the three-phase alternating current power to the charging and discharging port 10, and a second battery charging mode for applying the single-phase alternating current power to the charging and discharging port 10.

When the first battery charging mode is executed, the controller 2 may connect the first relay RLY_L1, the second relay RLY_L2, and the third relay RLY_L3 to establish connections, respectively, and may switch on the first leg L11, the second leg L12, and the third leg L13 of the power factor correction circuit 200 in such a manner that the bidirectional charger 1 charges the battery with the three-phase alternating current power.

When the second battery charging mode is executed, the single-phase alternating current power may be input into the first charging and discharging alternating-current terminal L1 of the charging and discharging port 10. Furthermore, the controller 2 may turn on the first relay RLY_L1, the interleave relay RLY_L1_L2, and the neutral terminal relay RLYN_A to attain connected states, respectively, and may switch on the first leg L11, the second leg L12, and the third leg L13 of the power factor correction circuit 200 in such a manner that the bidirectional charger 1 charges the battery with the single-phase alternating current power.

In an embodiment, a battery discharging mode may include a first battery discharging mode for outputting the electric power of the battery through the charging and discharging port 10, and a second battery discharging mode for outputting the electric power of the battery through the discharging port 20. Control of the battery discharging mode according to an embodiment of the present disclosure will be described below with reference to FIG. 3.

FIG. 3 is the diagram that is referred to for the description of control in a battery discharging mode according to an embodiment of the present disclosure.

With reference to FIGS. 1 and 3, when the first battery discharging mode is executed, the controller 2 may turn on the first relay RLY_L1, the interleave relay RLY_L1_L2, and the neutral terminal relay RLY_N_A to attain connected states, respectively. Furthermore, the controller 2 may switch on the first leg L11 and the third leg L13 of the power factor correction circuit 200 in such a manner that the bidirectional charger 1 outputs the electric power of the battery through the charging and discharging port 10.

In this case (first battery discharging mode), the controller 2 may disconnect the discharging relay RLY_V2L in such a manner that the bidirectional charger 1 does not output the electric power of the battery through the discharging port 20.

When the second battery discharging mode is executed, the controller 2 may turn on the discharging relay RLY_V2L to establish a connection and may switch on the second leg L12 and the third leg L13 of the power factor correction circuit 200 in such a manner that the bidirectional charger 1 outputs the electric power of the battery through the discharging port 20. In this case (second battery discharging mode), the controller 2 may disconnect the first relay RLY_L1, the interleave relay RLY_L1_L2, and the neutral terminal relay RLY_N_A in such a manner that the bidirectional charger 1 does not output the electric power of the battery through the charging and discharging port 10.

In addition, the controller 2 may execute a simultaneous driving mode (that is, may simultaneously execute the first battery discharging mode and the second battery discharging mode) in which the bidirectional charger 1 outputs the electric power of the battery through the charging and discharging port 10 and the discharging port 20. When the simultaneous driving mode is executed, the controller 2 may turn on the first relay RLY_L1, the interleave relay RLY_L1_L2, the neutral terminal relay RLY_N_A, and the discharging relay RLY_V2L to establish connections, respectively.

According to the above-described embodiments of the present disclosure, the plurality of relays can be enabled to share the isolating function of isolating electric power from the external source. This can decrease a current capacity required of each relay, thereby achieving a reduction in size and manufacturing costs.

In addition, isolation between different discharging ports can be performed through the plurality of relays provided to isolate electric power from the external source. This can eliminate the need for a separate relay for isolation between the discharging ports, thereby also achieving a reduction in manufacturing costs.

The specific embodiment of the present disclosure is described above with reference to the accompanying drawings. However, it would be obvious to a person of ordinary skill in the art that various modifications and alterations are possibly made to an embodiment of the present disclosure without departing from the technical ideas of the present disclosure that is claimed in the following claims.

What is claimed is:

1. A battery charging apparatus comprising:
a charging and discharging port comprising first to third charging and discharging alternating-current terminals and a neutral terminal, the battery charging apparatus being configured to transfer an external electric power to a battery through the charging and discharging port or transfer a battery electric power of the battery to an external source through the charging and discharging port;
a power factor correction circuit comprising first to third inductors that correspond to the first to third charging and discharging alternating-current terminals, respectively;
a first relay electrically coupled between the first charging and discharging alternating-current terminal and the first inductor;
an interleave relay, one terminal of the interleave relay being electrically coupled between the first charging and discharging alternating-current terminal and the first relay, and another terminal of the interleave relay being electrically coupled between the second charging and discharging alternating-current terminal and the second inductor; and
a controller configured to control a connected or disconnected state of the first relay and a connected or disconnected state of the interleave relay.

2. The apparatus of claim 1, wherein the first relay and the interleave relay have respective current capacities that are equivalent to each other.

3. The apparatus of claim 1, wherein the battery charging apparatus is configured to input a single-phase alternating current power into the first charging and discharging alternating-current terminal.

4. The apparatus of claim 1, wherein the battery charging apparatus is configured to input alternating current powers that correspond to three phases, respectively, of a three-phase alternating current power, into the first to third charging and discharging alternating-current terminals, respectively.

5. The apparatus of claim 1, further comprising:
a second relay electrically coupled to the second charging and discharging alternating-current terminal;
a third relay electrically coupled to the third charging and discharging alternating-current terminal; and
a neutral terminal relay electrically coupled to the neutral terminal.

6. The apparatus of claim 1, wherein the controller is further configured to connect the first relay and connect the interleave relay in order to transfer the battery electric power of the battery to the external source through the charging and discharging port.

7. The apparatus of claim 1, further comprising:
a pre-charging relay; and
a pre-charging resistor, wherein the pre-charging relay is electrically coupled in series to the pre-charging resistor between one terminal of the first relay and another terminal of the first relay.

8. The apparatus of claim 7, wherein the pre-charging relay has a lower current capacity than the first relay.

9. The apparatus of claim 7, wherein the controller is configured to connect the pre-charging relay in response to an alternating current power starting to be input into the first charging and discharging alternating-current terminal.

10. The apparatus of claim 7, wherein the controller is configured to disconnect the pre-charging relay in response to a voltage applied to the first inductor falling within a preset range.

11. The apparatus of claim 1, further comprising a discharging port, the discharging port comprising a first discharging alternating-current terminal and a second discharging alternating-current terminal, wherein the battery charging apparatus is further configured to transfer the battery electric power of the battery to the external source through the discharging port.

12. The apparatus of claim 11, wherein the second discharging alternating-current terminal of the discharging port is electrically coupled between the interleave relay and the second inductor, and
wherein the first discharging alternating-current terminal of the discharging port is electrically coupled between the third charging and discharging alternating-current terminal and the third inductor.

13. The apparatus of claim 12, further comprising a discharging relay electrically coupled between the first discharging alternating-current terminal and the second discharging alternating-current terminal.

14. The apparatus of claim 13, wherein the controller is configured to connect the discharging relay in order to transfer the battery electric power of the battery through the discharging port.

15. The apparatus of claim 13, wherein the controller is configured to selectively connect or disconnect the first relay, the interleave relay, and the discharging relay in response to a discharge mode of the battery.

16. The apparatus of claim 15, wherein the discharging mode of the battery comprises a first battery discharging mode for transferring the battery electric power of the battery to the external source through the charging and discharging port, and
wherein the controller is configured to connect the first relay, connect the interleave relay, and disconnect the discharging relay, in response to the first battery discharging mode.

17. The apparatus of claim 15, wherein the discharging mode of the battery comprises a second battery discharging mode for transferring the battery electric power of the battery to the external source through the discharging port, and
wherein the controller is configured to connect the discharging relay, disconnect the first relay, and disconnect the interleave relay, in response to the second battery discharging mode.

18. The apparatus of claim 15, wherein the discharging mode of the battery comprises a simultaneous driving mode for transferring the battery electric power of the battery to the external source through the charging and discharging port and through the discharging port, and
wherein the controller is configured to connect the first relay, connect the interleave relay, and connect the discharging relay, in response to the simultaneous driving mode.

19. A battery charging apparatus comprising:
a charging and discharging port comprising first to third charging and discharging alternating-current terminals and a neutral terminal, the battery charging apparatus being configured to transfer an external electric power to a battery through the charging and discharging port or transfer a battery electric power of the battery to an external source through the charging and discharging port;
a power factor correction circuit comprising first to third inductors that correspond to the first to third charging and discharging alternating-current terminals, respectively;
a first relay electrically coupled between the first charging and discharging alternating-current terminal and the first inductor;
an interleave relay, one terminal of the interleave relay being electrically coupled between the first charging and discharging alternating-current terminal and the first relay, and another terminal of the interleave relay being electrically coupled between the second charging and discharging alternating-current terminal and the second inductor;
a discharging port, the discharging port comprising a first discharging alternating-current terminal and a second discharging alternating-current terminal, wherein the battery charging apparatus is further configured to transfer the battery electric power of the battery to the external source through the discharging port,
wherein the first discharging alternating-current terminal of the discharging port is electrically coupled between the third charging and discharging alternating-current terminal and the third inductor, and
wherein the second discharging alternating-current terminal of the discharging port is electrically coupled between the interleave relay and the second inductor;
a discharging relay electrically coupled between the first discharging alternating-current terminal and the second discharging alternating-current terminal; and
a controller configured to control a connected or disconnected state of the first relay and a connected or disconnected state of the interleave relay,
wherein the controller is further configured to connect the discharging relay in order to transfer the battery electric power of the battery through the discharging port,
wherein the controller is further configured to selectively connect or disconnect the first relay, the interleave relay, and the discharging relay in response to a discharge mode of the battery,
wherein the discharging mode of the battery comprises a first battery discharging mode for transferring the battery electric power of the battery to the external source through the charging and discharging port,
wherein the controller is further configured to connect the first relay, connect the interleave relay, and disconnect the discharging relay, in response to the first battery discharging mode,
wherein the discharging mode of the battery comprises a second battery discharging mode for transferring the battery electric power of the battery to the external source through the discharging port,
wherein the controller is further configured to connect the discharging relay, disconnect the first relay, and disconnect the interleave relay, in response to the second battery discharging mode,
wherein the discharging mode of the battery further comprises a simultaneous driving mode for transferring the battery electric power of the battery to the external source through the charging and discharging port and through the discharging port, and
wherein the controller is further configured to connect the first relay, connect the interleave relay, and connect the discharging relay, in response to the simultaneous driving mode.

20. A battery charging apparatus comprising:
a charging and discharging port comprising first to third charging and discharging alternating-current terminals and a neutral terminal, the battery charging apparatus being configured to transfer an external electric power to a battery through the charging and discharging port or transfer a battery electric power of the battery to an external source through the charging and discharging port;
a power factor correction circuit comprising first to third inductors that correspond to the first to third charging and discharging alternating-current terminals, respectively;
a first relay electrically coupled between the first charging and discharging alternating-current terminal and the first inductor;
a second relay electrically coupled to the second charging and discharging alternating-current terminal;
a third relay electrically coupled to the third charging and discharging alternating-current terminal;
a neutral terminal relay electrically coupled to the neutral terminal;
a pre-charging relay;
a pre-charging resistor, wherein the pre-charging relay is electrically coupled in series to the pre-charging resistor between one terminal of the first relay and another terminal of the first relay;
an interleave relay, one terminal of the interleave relay being electrically coupled between the first charging and discharging alternating-current terminal and the first relay, and another terminal of the interleave relay being electrically coupled between the second charging and discharging alternating-current terminal and the second inductor;
a discharging port, the discharging port comprising a first discharging alternating-current terminal and a second discharging alternating-current terminal, wherein the battery charging apparatus is further configured to transfer the battery electric power of the battery to the external source through the discharging port,
wherein the first discharging alternating-current terminal of the discharging port is electrically coupled between the third charging and discharging alternating-current terminal and the third inductor, and
wherein the second discharging alternating-current terminal of the discharging port is electrically coupled between the interleave relay and the second inductor;
a discharging relay electrically coupled between the first discharging alternating-current terminal and the second discharging alternating-current terminal; and
a controller configured to control a connected or disconnected state of the first relay and a connected or disconnected state of the interleave relay,
wherein the controller is further configured to connect the first relay and connect the interleave relay in order to transfer the battery electric power of the battery to the external source through the charging and discharging port,
wherein the battery charging apparatus is further configured to input a single-phase alternating current power into the first charging and discharging alternating-current terminal,
wherein the battery charging apparatus is further configured to input alternating current powers that correspond to three phases, respectively, of a three-phase alternating current power, into the first to third charging and discharging alternating-current terminals, respectively,
wherein the controller is further configured to connect the pre-charging relay in response to an alternating current power starting to be input into the first charging and discharging alternating-current terminal,
wherein the controller is further configured to disconnect the pre-charging relay in response to a voltage applied to the first inductor falling within a preset range,
wherein the controller is further configured to connect the discharging relay in order to transfer the battery electric power of the battery through the discharging port,
wherein the controller is further configured to selectively connect or disconnect the first relay, the interleave relay, and the discharging relay in response to a discharge mode of the battery,
wherein the discharging mode of the battery comprises a first battery discharging mode for transferring the battery electric power of the battery to the external source through the charging and discharging port,
wherein the controller is further configured to connect the first relay, connect the interleave relay, and disconnect the discharging relay, in response to the first battery discharging mode,
wherein the discharging mode of the battery further comprises a second battery discharging mode for transferring the battery electric power of the battery to the external source through the discharging port,
wherein the controller is further configured to connect the discharging relay, disconnect the first relay, and disconnect the interleave relay, in response to the second battery discharging mode,
wherein the discharging mode of the battery further comprises a simultaneous driving mode for transferring the battery electric power of the battery to the external source through the charging and discharging port and through the discharging port, and
wherein the controller is further configured to connect the first relay, connect the interleave relay, and connect the discharging relay, in response to the simultaneous driving mode.
